(19) United States
(12) Patent Application Publication
(10) Pub. No.: US 2013/0029178 A1
(43) Pub. Date: Jan. 31, 2013

(54) ACTIVE SOLDER

(71) Applicants: Shih-Ying CHANG, (US); Lung-Chuan Tsao, (US); Tung-Han Chuang, (US); Yen-Huan Lei, (US); Cheng-Kai Li, (US); Wei-Chia Huang, (US)

(72) Inventors: Shih-Ying CHANG, (US); Lung-Chuan Tsao, (US); Tung-Han Chuang, (US); Yen-Huan Lei, (US); Cheng-Kai Li, (US); Wei-Chia Huang, (US)

(21) Appl. No.: 13/191,965

(22) Filed: Jul. 27, 2011

(51) Int. Cl. B23K 35/24; B32B 15/01

(52) U.S. Cl. 428/646; 428/615; 428/660; 428/649

(57) ABSTRACT

An active solder is revealed. The active solder includes an active material and a metal substrate. There are two kinds of active materials, titanium together with rare earth elements and magnesium. The metal substrate is composed of a main component and an additive. The main component is tin-zinc alloy and the additive is selected from bismuth, indium, silver, copper or their combinations. The active solder enables targets and backing plates to be joined with each other directly in the atmosphere. The target is ceramic or aluminum with low wetting properties. The bonding temperature of the active solder ranges from 150° C. to 200° C. so that the problem of thermal stress can be avoided.

### BACKGROUND OF THE INVENTION

1. Fields of the Invention

The present invention relates to an active solder, especially to an active solder that is used to join a target having low wetting properties and metal directly in the atmosphere.

2. Descriptions of Related Art

Sputtering is a process in which atoms are ejected from a target material due to bombardment of the target by energetic particles and then are deposited onto a substrate to form a thin film. In a vacuum chamber, energetic particles used to strike the target material are generated by glow-discharge. The applications of sputtering include etching and film deposition of plastic, metals, glass, cloth or composite materials, with advantages of high quality, good adhesion, process stability, etc.

In a general sputtering process, a voltage is applied to a side of target material. In a vacuum chamber, ions of the noble gas with positive charge collide with the target material. Then the target material is bombarded to produce atoms that are sputtered and deposited on the substrate. During the process, a large amount of heat is generated from the target material. In order to remove heat, a backing plate connected with the target material is cooled by water cooling. Once the bonding strength between the target material and the backing plate is poor or the heat conduction performance of the interface is poor, the temperature of the target material is increased dramatically during the sputtering process and some problems such as lift-off, melting or overheating occur.

There are a plurality of factors affecting the bonding between targets and backing plates such as strength, thermal conductivity, thermal resistance, operation convenience for joining, re-workable property of backing plates, and cost. In consideration of the requirements of joining temperature, operation temperature and thermal conductivity, indium is generally used as bonding material for the target and the backing plate. In most applications of bonding for various metal targets, the bonding and joining are completed smoothly due to good wetting properties of the melt indium.

The joint between ceramic and metal has received a plenty of attentions. The composite components produced by joining ceramic and metal have advantages of respective material and compensate each other's weakness. The key point of research is how to join ceramic to metal. The great difference in physical properties, chemical properties and bonding ways of the two materials results in difficulties in joining of ceramic and metal. The ceramic target is a material having low wetting properties. In order to make the surface of ceramic react and bond with metal, metallization on the surface of the ceramic to be joined is required. The ceramic can be metallized by several ways including thick film technology and thin film technology. The thin film technology includes vacuum coating such as evaporation and sputtering, chemical vapor deposition, ion implantation or chemical plating etc. The thick film technology has thick film technology has sintering of metal powder, coating of active brazing alloys, etc. After metallization, Indium is used to join. The above processes are complicated and costly.

Refer to Taiwanese Pat. No. 1321159, a solder alloy for connecting target and backing plates made from copper or copper alloy is revealed. The solder alloy features on that: 3% to 9% zinc by weight and residuals are tin and inevitable impurities. However, this solder is only applied to the target that is wetting and easily-soldered. As to the target having low wetting properties such as ceramic, no resolutions are proposed.

Refer to Refer to Taiwanese Pat. Pub. No. 201036741, an interface layer is formed on surface of ceramic sputtering target by coating a layer of pure chrome or chrome alloy. Then a solder layer of backing plates and the interface layer of the target are soldered. Next the interface layer is annealed so that the interface layer and the solder layer are joined easily. A target bonding way for target with lower wetting properties is provided. However, coating of the interface layer on the surface of the target in advance is required for convenience of soldering. The process of coating increases the cost and the bonding processes are complicated due to the annealing process. Moreover, the joining interfaces of multiple layers of metal have certain effect on the bonding performance.

Thus there is a need to provide a novel active solder and a method of the same used to join a target having low wetting properties such as ceramic, aluminum, aluminum alloy, etc. and a backing plate without above shortcomings.

### SUMMARY OF THE INVENTION

Therefore it is a primary object of the present invention to provide an active solder that joins a target having low wetting properties and a backing plate directly without a coating on surface of the target.

It is another object of the present invention to provide an active solder by which operators can join the target and the backing plate directly without protective equipments.

It is a further object of the present invention to provide an active solder having good wetting properties and suitable to join a target with low wetting properties and a backing plate Thus the bonding processes are simplified, processing time and cost are reduced.

It is a further object of the present invention to provide an active solder that is used at low temperature while bonding the target and the backing plate. Besides the safer operation, the problem of thermal stress can be solved and the bonding strength is increased.

It is a further object of the present invention to provide an active solder that includes zinc as one of metal substrates. The active solder has better ductility than general lead free solder and lower joining temperature. Thus the problem of thermal stress is reduced and the bonding strength is higher.

In order to achieve the above objects, an active solder of the present invention that joins a target with low wetting properties and a backing plate directly in the atmosphere is provided. The active solder includes an active material and a metal substrate. The active material includes titanium and rare earth elements, or magnesium. The main component of the metal substrate is tin-zinc alloy and others are Bismuth, Indium, Silver and Copper. The bonding temperature of the active solder 10 ranges from 150° C. (degrees Celsius) to 200° C., between low temperature solders and high temperature solders. Such temperature is low temperature for lead free solders. Thus the thermal stress of the bonding interface can be reduced. Moreover, the bonding temperature should be over 150° C., otherwise the target and the backing plate are separated from each other during sputtering. While manufacturing the active solder, the temperature is under 200° C. and this is lower than the temperature required by commercial lead free solders. Thus the manufacturing is faster, safer, and more convenient.

The active solder of the present invention is applied to bonding of the target that is difficult to be joined due to low wetting properties of the target. The target with low wetting properties are bonded with the backing plate directly due to the active material contained in the solder. Thus the cost and time are reduced and the bonding performance is improved. Moreover, the tin-zinc alloy in the metal substrate of the active solder has good durability so as to reduce the thermal stress.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing joining between an active solder and joined objects of an embodiment according to the present invention;

FIG. 2 is a flow chart of a method using an active solder for joining according to the present invention.

### DETAILED DESCRIPTION OF THE PREFERRED EMBODIMENT

The present invention relates to active solders. An active solder is used to join a target having low wetting properties with a backing plate directly in the atmosphere, without protective equipments.

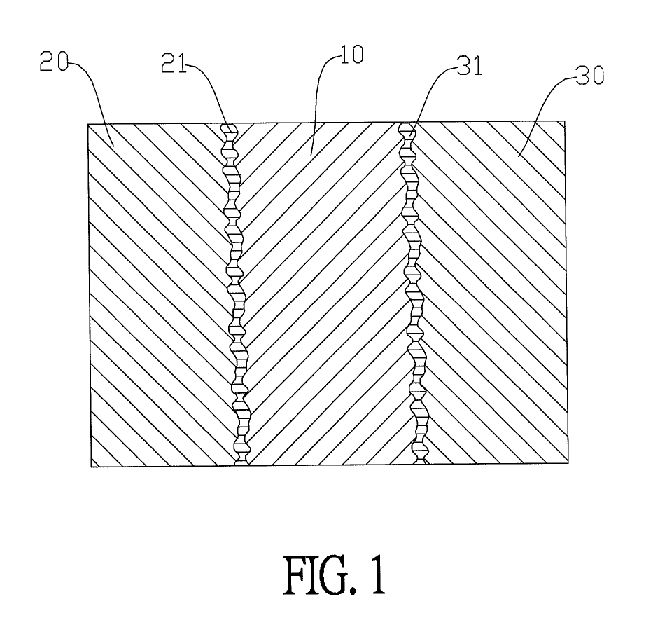

Refer to FIG. 1 and Table 1, structure of an embodiment and alloy composition are revealed. As show in the figure, an active solder 10 of the present invention includes an active material and a metal substrate. The active material includes titanium and rare earth elements. The rare earth element is selected from followings: lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), yttrium (Y), scandium (Sc), or their combinations. The main component of the metal substrate is tin-zinc alloy.

Moreover, the bonding temperature of the active solder 10 ranges from 150° C. (degrees Celsius) to 200° C. The active solder 10 further includes an additive selected from one of the followings: Bismuth, Indium, Silver, Copper or their combinations. The combination and ratio of the metals are shown in the Table 1.

TABLE 1
alloy composition chart of the first embodiment

| | Solder alloy | | | | | | | |
|---|---|---|---|---|---|---|---|---|
| | Sn | Zn | Bi | In | Ag | Cu | Ti | Re |
| R-SZB | residual | 5-15 | 0.1-10 | 0 | 0 | 0 | 2-10 | 0.01-1 |
| R-SZI | residual | 5-15 | 0 | 0.1-10 | 0 | 0 | 2-10 | 0.01-1 |
| R-SZA | residual | 5-15 | 0 | 0 | 0.1-10 | 0 | 2-10 | 0.01-1 |
| R-SZBI | residual | 5-15 | 0.1-10 | 0.1-10 | 0 | 0 | 2-10 | 0.01-1 |
| R-SZBA | residual | 5-15 | 0.1-10 | 0 | 0.1-10 | 0 | 2-10 | 0.01-1 |
| R-SZBC | residual | 5-15 | 0.1-10 | 0 | 0 | 0.1-5 | 2-10 | 0.01-1 |
| R-SZIA | residual | 5-15 | 0 | 0.1-10 | 0.1-10 | 0 | 2-10 | 0.01-1 |
| R-SZIC | residual | 5-15 | 0 | 0.1-10 | 0 | 0.1-5 | 2-10 | 0.01-1 |

In the atmosphere the active solder 10 joins a first joined object 20 and a second joined object 30 together directly. This is due to the active material-Titanium and rare earth elements in the active solder 10 react with as well as bond to the first joined object 20 and the second joined object 30. A first joining surface 21 is generated between the first joined object 20 and the active solder 10. Similarly, a second joining surface 31 is generated between the second joined object 30 and the active solder 10. The first joined object 20 is metal or ceramic. The second joined object 30 is metal or ceramic.

In this embodiment, active soldering makes it possible to join the active solder 10 directly with the first joined object 20 and the second joined object 30. As active components added into solders promote wetting on the target surface, the metal and the target with poor wetting properties such as ceramic etc. are reacted and joined easily. In the active soldering process, solder alloys are melt at high temperature ranging from 800° C. to 1000° C. so that problems of thermal stress and processing arise. In the present invention, the active solder 10 with active material (including titanium and rare earth elements) is used to join materials directly at temperature ranging from 150° C. to 200° C. with optimal performance. Users can adjust the temperature range according to the needs of the operation.

Due to extreme chemical affinity of the rare earth elements, the active material added into the active solders promote wetting on the target (such as ceramic) surface so that the target and the backing plate are joined directly without flux. Moreover, results of experiments show that the lowest temperature required for the joining process is no less than 150° C. Thus the target and the backing plate are joined tightly and are not separated during the sputtering process.

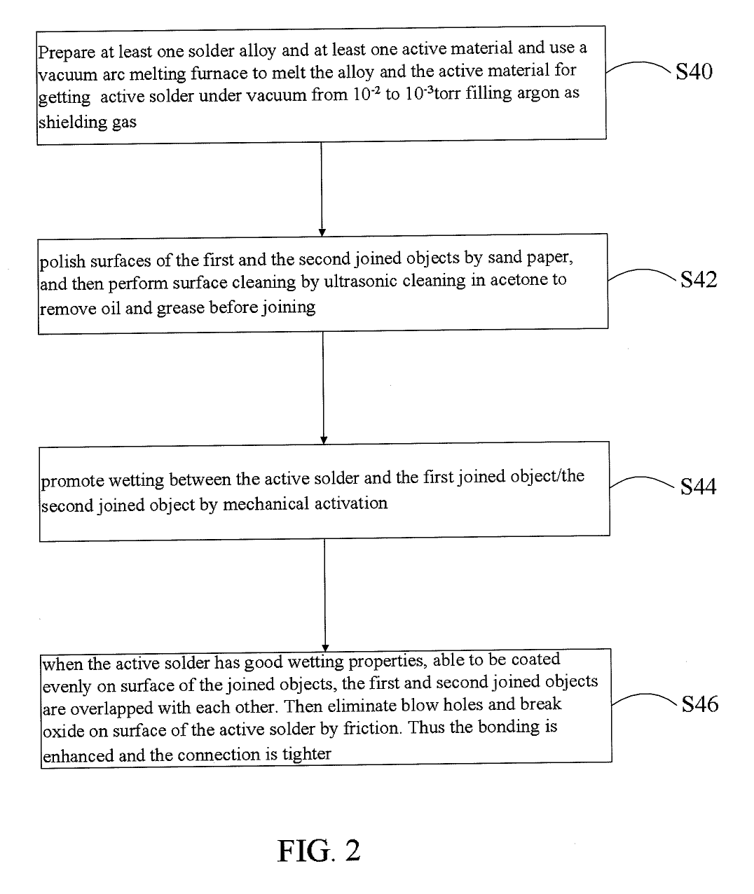

As shown in FIG. 2, an embodiment of a method using an active solder for joining targets having poor wetting properties and backing plates in the atmosphere according to the present invention includes following steps:
Step S40: prepare at least one solder alloy and at least one active material according to preset weight percentage. Use a vacuum arc melting furnace to melt the alloy and the active material. Use a pump to create a vacuum ranging from 10⁻² to 10⁻³ torr and fill argon as shielding gas so as to get active solder 10.
Step S42: polish surfaces of the first and the second joined objects 20, 30 by sand paper, and then perform surface cleaning by ultrasonic cleaning in acetone to remove oil and grease before joining.
Step S44: promote wetting between the active solder 10 and the first joined object 20/the second joined object 30 by mechanical activation.
Step S46: when the active solder 10 has good wetting properties, able to be coated evenly on surface of the joined objects, the first and second joined objects 20, 30 are overlapped with each other. Then eliminate blow holes and break oxide on surface of the active solder 10 by friction. Thus the bonding is enhanced and the connection is tighter.

In the above embodiment, the rare earth elements are used as active material in active soldering. However, the rare earth elements are expensive due to limited production and only a few deposits on certain countries. The raw materials are difficult to obtain. Thus the active material added in the active solder is replaced by magnesium in a second embodiment of the present invention. Refer to FIG. 1 and Table (Chart) 2, another embodiment is revealed. An active solder 10 consists of an active material and metal substrate. The active material is magnesium or magnesium alloy while the main component of the metal substrate is tin-zinc alloy.

The bonding temperature of the active solder 10 is between 150° C. and 200° C. The active solder 10 further includes an additive selected from one of the followings: Bismuth, Indium, Silver, Copper or their combinations. The combination and ratio of the metals included in the active solder 10 are shown in the Table 2.

TABLE 2
alloy composition chart of the second embodiment

| | Solder alloy | | | | | | |
|---|---|---|---|---|---|---|---|
| | | | | | | | Mg or |
| | | | | | | | Mg |
| | Sn | Zn | Bi | In | Ag | Cu | alloy |
| M-SZB | residual | 5-15 | 0.1-10 | 0 | 0 | 0 | 0.1-5 |
| M-SZI | residual | 5-15 | 0 | 0.1-10 | 0 | 0 | 0.1-5 |
| M-SZA | residual | 5-15 | 0 | 0 | 0.1-10 | 0 | 0.1-5 |
| M-SZBI | residual | 5-15 | 0.1-10 | 0.1-10 | 0 | 0 | 0.1-5 |
| M-SZBA | residual | 5-15 | 0.1-10 | 0 | 0.1-10 | 0 | 0.1-5 |
| M-SZBC | residual | 5-15 | 0.1-10 | 0 | 0 | 0.1-5 | 0.1-5 |
| M-SZIA | residual | 5-15 | 0 | 0.1-10 | 0.1-10 | 0 | 0.1-5 |
| M-SZIC | residual | 5-15 | 0 | 0.1-10 | 0 | 0.1-5 | 0.1-5 |

The active solder 10 can join a first joined object 20 and a second joined object 30 directly in the atmosphere. This is due to an active element-magnesium that reacts with and bond to the first joined object 20 and the second joined object 30 respectively. A first joining surface 21 is generated between the first joined object 20 and the active solder 10 while a second joining surface 31 is generated between the second joined object 30 and the active solder 10. The first joined object 20 is metal or ceramic. The second joined object 30 is metal or ceramic.

In the first embodiment, active soldering makes it possible to join the active solder 10 directly with the first joined object 20 and the second joined object 30. As active components added into solders promote wetting on the target surface, the metal and the target with poor wetting properties such as ceramic etc. are reacted and joined easily. In the active soldering process, solder alloys are melt at high temperature ranging from 800° C. to 1000° C. so that problems of thermal stress and processing arise. By the active solder added with the active element-magnesium, the cost is dramatically reduced and the wetting properties on the surface of the target are promoted. The joining performance of the active solder with magnesium is as good as the active solder added with active element-titanium and rare earth elements.

As shown in FIG. 2, another embodiment of a method using an active solder for joining targets having poor wetting properties and backing plates in the atmosphere according to the present invention includes following steps:
Step S40: prepare at least one solder alloy and at least one active material according to preset weight percentage and use a vacuum arc melting furnace to melt the alloy and the active material. Use a pump to create a vacuum ranging from 10⁻² to 10⁻³ torr and fill argon as shielding gas so as to get active solder 10;
Step S42: polish surfaces of the first and the second joined objects 20, 30 by sand paper, and then perform surface cleaning by ultrasonic cleaning in acetone to remove oil and grease before joining.
Step S44: promote wetting between the active solder 10 and the first joined object 20/the second joined object 30 by mechanical activation.
Step S46: when the active solder 10 has good wetting properties, able to be coated evenly on surface of the joined objects, the first and second joined objects 20, 30 are overlapped with each other. Then eliminate blow holes and break oxide on surface of the active solder 10 by friction. Thus the bonding is enhanced and the connection is tighter.

In summary, an active solder and a method that joins target and a backing plate by the active solder of the present invention promote wetting on the target surface by the active material so as to complete the joining directly. There is no need to coat a metal layer on the target surface before the joining processes. Moreover, the present invention has following advantages:

1. The active solder of the present invention joins target having low wetting properties and backing plates directly without special protective equipments. This is convenient in use. Thus the cost is reduced and the processes are simplified.

2. The bonding temperature of the active solder is ranging from 150° C. to 200° C., between low temperature solders and high temperature solders. Thus the problem of thermal stress can be reduced. Moreover, the temperature range falls within previous operation range so that the processes can be performed by original equipment. There is no need to buy new equipment.

3. The active solder of the present invention features on that metal substance is added with a certain ratio of active elements so as to react with and bond to the target with low wetting properties and backing plates. The target with low wetting properties and backing plates are joined in the atmosphere effectively without flux. The cost is reduced and the processes are simplified.

4. The metal substrate of the active solder according to the present invention is softer, compared with other common solders. Thus the problem of thermal stress is overcome and the adhesive strength is improved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. An active solder comprising:
an active material selected from titanium and at least one rare earth element; and
a metal substrate.

2. The active solder as claimed in claim 1, wherein the active solder further includes:
an additive that is bismuth, indium, silver, or copper and a weight percent of the additive in the active solder ranges from 0.1% to 10%.

3. The active solder as claimed in claim 1, wherein the active solder further includes:
an additive that is bismuth, indium, or copper; a weight percent of bismuth in the active solder ranges from 0.1% to 10%; a weight percent of indium in the active solder ranges from 0.1% to 10%; and a weight percent of copper in the active solder ranges from 0.1% to 5%.

4. The active solder as claimed in claim 1, wherein the rare earth element is lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), yttrium (Y), scandium (Sc), or their combinations.

5. The active solder as claimed in claim 1, wherein the metal substrate includes tin-zinc alloy.

6. An active solder comprising:
an active material that is magnesium; and
a metal substrate.

7. The active solder as claimed in claim 6, wherein the active solder further includes:
an additive that is bismuth, indium, silver, or copper and a weight percent of the additive in the active solder ranges from 0.1% to 10%.

8. The active solder as claimed in claim 6, wherein the active solder further includes:
an additive that is bismuth, indium, or copper; a weight percent of bismuth in the active solder ranges from 0.1% to 10%; a weight percent of indium in the active solder ranges from 0.1% to 10%; and a weight percent of copper in the active solder ranges from 0.1% to 5%.

9. The active solder as claimed in claim 6, wherein the metal substrate includes tin-zinc alloy.
